(19) United States
(12) Patent Application Publication
(10) Pub. No.: US 2009/0208819 A1
(43) Pub. Date: Aug. 20, 2009

(54) Rechargeable Battery Pack for Power Tools

(76) Inventors: Nathan Cruise, Phoenix, MD (US); Andrew E. Seman, JR., White Marsh, MD (US); Fugen Qin, Baltimore, MD (US); Daniele C. Brotto, Baltimore, MD (US); Tal Gottesman, Towson, MD (US); Michael Varipatis, Parkville, MD (US); Brian K. Wohltmann, Rosedale, MD (US); Steven J. Phillips, Ellicott City, MD (US); Regina Gracia C. Cunanan, Parkville, MD (US); Stephen P. Osborne, Baltimore, MD (US); Geoffrey S. Howard, Columbia, MD (US); Paul Stephenson, Owings Mills, MD (US); Joshua D. West, Towson, MD (US)

Correspondence Address: THE BLACK & DECKER CORPORATION, 701 EAST JOPPA ROAD, TW199, TOWSON, MD, 21286, US

(21) Appl. No.: 12/389,471

(22) Filed: Feb. 20, 2009

Related U.S. Application Data
(60) Provisional application No. 61/066,339, filed on Feb. 20, 2008.

(51) Int. Cl. H01M 10/44; H01M 2/00

(52) U.S. Cl. 429/50; 429/61

(57) ABSTRACT

A rechargeable battery pack comprises a battery having a high voltage side and a low voltage side, a positive terminal accessible external of the battery pack and connected to the high voltage side of the battery, a negative terminal accessible external of the battery pack and connected to the low voltage side of the battery, a control terminal accessible external of the battery pack, a switching element electrically connected between the control terminal and the high voltage side of the battery, and a control module operable to control the switching element so that the control terminal is selectively coupled to the high voltage side of the battery.

This application claims domestic priority under 35 U.S.C. §120 to U.S. Provisional Patent Application Ser. No. 61/066,339, filed in the United States Patent & Trademark Office on Feb. 20, 2008. The entire contents of the disclosure for the provisional application is incorporated herein by reference.

### FIELD

The present disclosure relates to rechargeable battery packs, and more specifically to rechargeable battery packs for power tools.

### BACKGROUND

Rechargeable battery packs may provide a power source for cordless power tools. The battery pack may have a battery with a design voltage and may provide power to operate a power tool. The battery itself may consist of a number of individual battery cells that may be combined within the battery pack to provide a desired design voltage. For example, a nickel cadmium (NiCad) battery may have a design voltage such as 18, 15, 12 or 9 volts. Another battery type may be a lithium-ion battery. A lithium-ion battery may also have any of a number of design voltages, an example of which may be 12 volts.

Lithium-ion batteries may have different characteristics than NiCad batteries. For example, in cordless power tool applications it may be desirable to have a lighter battery pack. A lithium-ion battery may provide the same power to a power tool as a comparable NiCad battery but may weigh significantly less. Lithium-ion batteries may also operate without the memory effect often associated with NiCad batteries.

A battery pack may be interchangeable with a number of power tools. Accordingly, a battery pack may have a standardized terminal arrangement to interconnect the high and low side of the battery with numerous power tools. It may be desirable to provide some form of control or communication between the battery pack and a power tool. In this manner, conditions such as a user commanded condition from the tool or a measured parameter from the power tool may impact the interaction of the battery pack and power tool. For example, it may be desirable to prevent operation of the power tool when the battery pack voltage drops below a predetermined voltage, such as 0.5 V in any battery cell, or if the battery pack temperature exceeds a predetermined maximum temperature such as 70° C.

A battery pack may also be charged by a charger. The battery pack may require terminals to contact a battery high side and low side to the charger power source. A terminal may also be required to allow the battery pack and charger to communicate in order to monitor charging progress and provide for an efficient charging algorithm. In this manner, overcharging of the battery may be prevented and the battery charging may occur at a faster rate.

A complete system may include battery packs, a battery charger, and a number of power tools. It may be desirable to design a system such that components are easily interchangeable with an efficient use of electrical components and terminal connections, while still maintaining all of the functionality described above.

The statements in this section merely provide background information related to the present disclosure and may not constitute prior art.

### SUMMARY

A rechargeable battery pack comprises a battery having a high voltage side and a low voltage side, a positive terminal accessible external of the battery pack and connected to the high voltage side of the battery, a negative terminal accessible external of the battery pack and connected to the low voltage side of the battery, a control terminal accessible external of the battery pack, a switching element electrically connected between the control terminal and the high voltage side of the battery, and a control module operable to control the switching element so that the control terminal is selectively coupled to the high voltage side of the battery.

A rechargeable battery pack comprises a battery having a high voltage side and a low voltage side, a high-side terminal connected to the battery high voltage side, a low side terminal connected to the battery low voltage side, a control terminal, and a control module selectively connecting the control terminal to one of a battery high voltage side voltage, a voltage less than the battery high voltage side voltage, and a communication signal of the control module transitioning between a high communication voltage and a low communication voltage.

A tool operable to connect to a battery pack comprises a high voltage input, a low voltage input, a load, a switching element operable to open or close a series circuit path including the high voltage input, the load, and the low voltage input, a control input; and a control module operable to control the switching element, wherein the control module is powered by the control input and operates at voltage of at least 5 volts.

A method for operating a battery pack, the battery pack having a positive terminal connected to a high voltage side of a battery enclosed therein, a negative terminal connected to a low voltage side of the battery, and a control terminal, comprises sending an inquiry communication signal from the battery pack via the control terminal, sending an additional communication signal from the battery pack via the control terminal when a response signal to the inquiry communication signal is received at the control terminal, and connecting the control terminal to the high voltage side of the battery when a response signal to the inquiry communication signal is not received by the battery pack.

A method of operating a battery pack comprises applying a pull-up voltage to a control terminal of the battery pack, determining whether a voltage of the control terminal is less than a predetermined presence voltage, and providing signals to the control terminal when the voltage of the control terminal is less than the predetermined presence voltage, including providing a communication signal from a control module of the battery pack to the control terminal, determining whether a response is received at the control terminal, and providing a voltage connected to a high voltage side of the battery pack through a circuit element to the control terminal when the response is not received at the control terminal.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a drawing depicting a tool system, including a battery pack, power tools, and a charger;

FIG. 2 is a functional block diagram of a tool connected to a battery pack;

FIG. 3 is a functional block diagram of a battery pack connected to a charger;

FIG. 4 is a signal diagram demonstrating operation of a battery pack when connected to a tool or a charger from sleep mode;

FIG. 5 is a signal diagram demonstrating operation of a battery pack checking status while operating in tool mode;

FIG. 6 is an electrical schematic illustration of a battery pack;

FIG. 7 is an electrical schematic illustration of a power tool for use with the battery pack of FIG. 6;

FIG. 8 is an electrical schematic illustration of a charger for use with the battery pack of FIG. 6; and

FIG. 9 is a flow diagram depicting steps of operation of the battery pack of FIG. 6 with the power tool of FIG. 7 and the charger of FIG. 8.

### DETAILED DESCRIPTION

The following description is merely exemplary in nature and is in no way intended to limit the invention, its application, or uses. For purposes of clarity, the same reference numbers may be used in the drawings to identify the same elements. As used herein the term module, controller and/or device refers to an application specific integrated circuit (ASIC), an electronic circuit, a processor (shared, dedicated, or group) or memory that execute one or more software or firmware programs, a combinational logic circuit, or other suitable components that provide the described functionality.

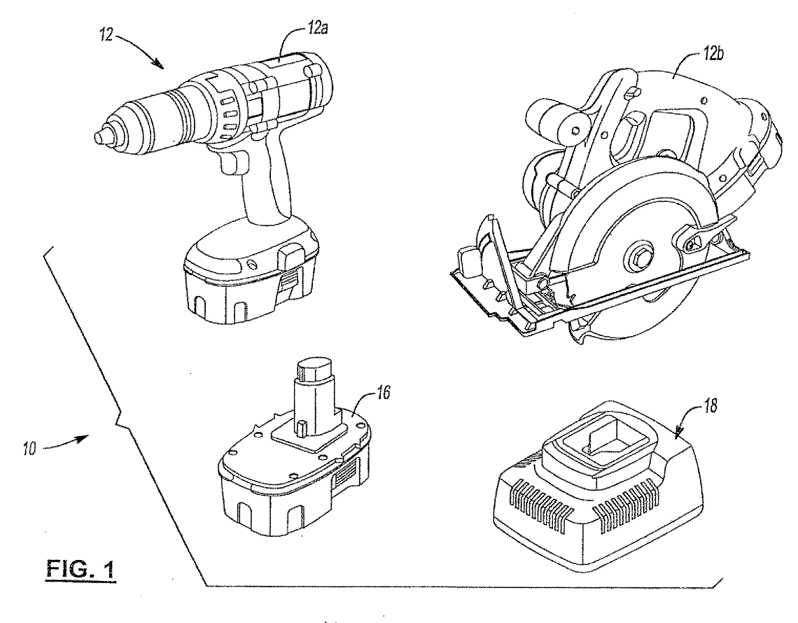

The present disclosure can relate to a system of power tools of the type that is generally indicated by reference numeral 10 in FIG. 1. The system of power tools 10 can include, for example, one or more power tools 12, a battery pack 16 and a battery pack charger 18. Each of the power tools 12 can be any type of power tool, including without limitation drills, drill/drivers, hammer drill/drivers, rotary hammers, screwdrivers, impact drivers, circular saws, jig saws, reciprocating saws, band saws, cut-off tools, cut-out tools, shears, sanders, vacuums, lights, routers, adhesive dispensers, concrete vibrators, lasers, staplers and nailers. In the particular example provided, the system of power tools 10 includes a first power tool 12a and a second power tool 12b. For example, the first power tool 12a can be a drill/driver similar to that which is described in U.S. Pat. No. 6,431,389, while the second power tool 12b can be a circular saw similar to that which is described in U.S. Pat. No. 6,996,909. The battery pack 16 can be selectively removably coupled to the first and second power tools 12a and 12b to provide electrical power thereto. It is noteworthy that the broader aspects of this disclosure are applicable to other types of battery powered devices.

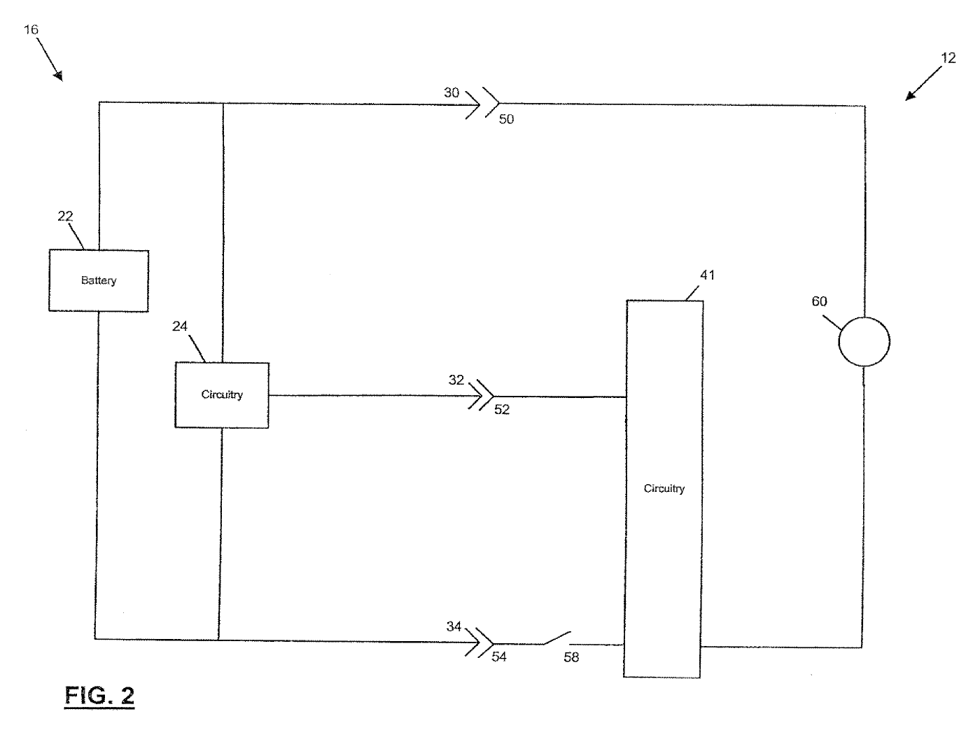

Referring now to FIG. 2, a functional block diagram of a tool 12 connected to battery pack 16 is depicted. Tool 12 includes circuitry 41, high-side terminal 50, control terminal 52, low side terminal 54, switch 58, and load 60. Battery pack 16 includes battery 22, circuitry 24, high-side terminal 30, control terminal 32, and low side terminal 34. The respective high-side terminals 30 and 50, control terminals 32 and 52, and low side terminals 34 and 54 may be located at an exterior surface of tool 12 and battery pack 16 to interconnect and selectively provide power from battery 22 of battery pack 16 to a load 60 of tool 12.

Switch 58 may selectively close a circuit to allow load 60 to be powered by battery 22. In addition, circuitry 41 may selectively close a circuit to allow load 60 to be powered by battery 22. Circuitry 41 may only close the circuit when a voltage greater than a predetermined minimum voltage is provided at control terminal 52. This voltage may be provided through control terminal 32 of battery pack 16 by circuitry 24. Circuitry 24 may selectively connect control terminal 32 to a high voltage side of battery 22, which in turn may allow circuitry 41 to operate to selectively close a circuit to allow power to be provided to load 60.

Circuitry 24 may be operable to provide multiple output voltages to control terminal 32. These voltages may include connecting control terminal 32 to a high voltage side of battery 22, providing a 3 volt communication signal to control terminal 32, and providing a high impedance output at control terminal 32. The high impedance output may allow circuitry 24 to sense a tool 12 (or a charger 18) when a pull-down voltage is provided at control terminal 32. Circuitry 41 may provide a pull-down voltage to control terminal 32 through control terminal 52, but only when switch 58 is closed.

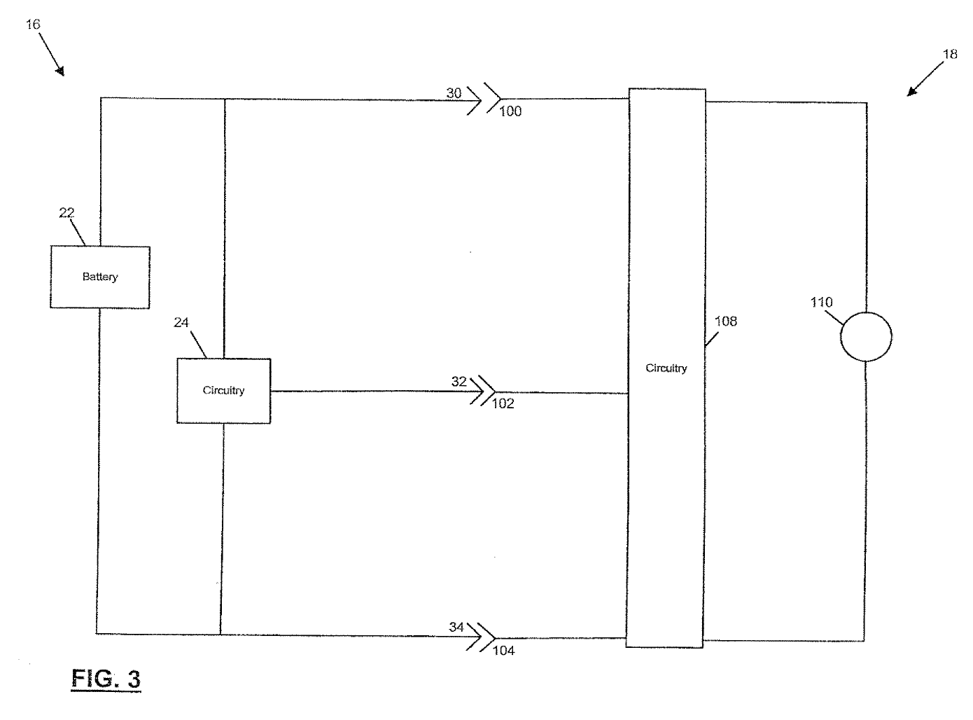

Referring now to FIG. 3, a functional block diagram of battery pack 16 connected to charger 18 is depicted. Battery pack 16 may include components and may operate as described above. Charger 18 may include high-side terminal 100, control terminal 102, low side terminal 104, circuitry 108, and power supply 110. The respective high-side terminals 30 and 100, control terminals 32 and 102, and low side terminals 34 and 104 may be located at an exterior surface of battery pack 16 and charger 18 to interconnect and selectively provide power from power supply 110 of charger 18 to charge battery 22 of battery pack 16.

Circuitry 108 may include a pull-down voltage to allow circuitry 24 of battery pack 16 to sense the presence of battery pack 12 through control terminals 102 and 32. Circuitry 108 may also include circuitry to communicate with circuitry 24 of battery pack 16, such as through volt communication signals.

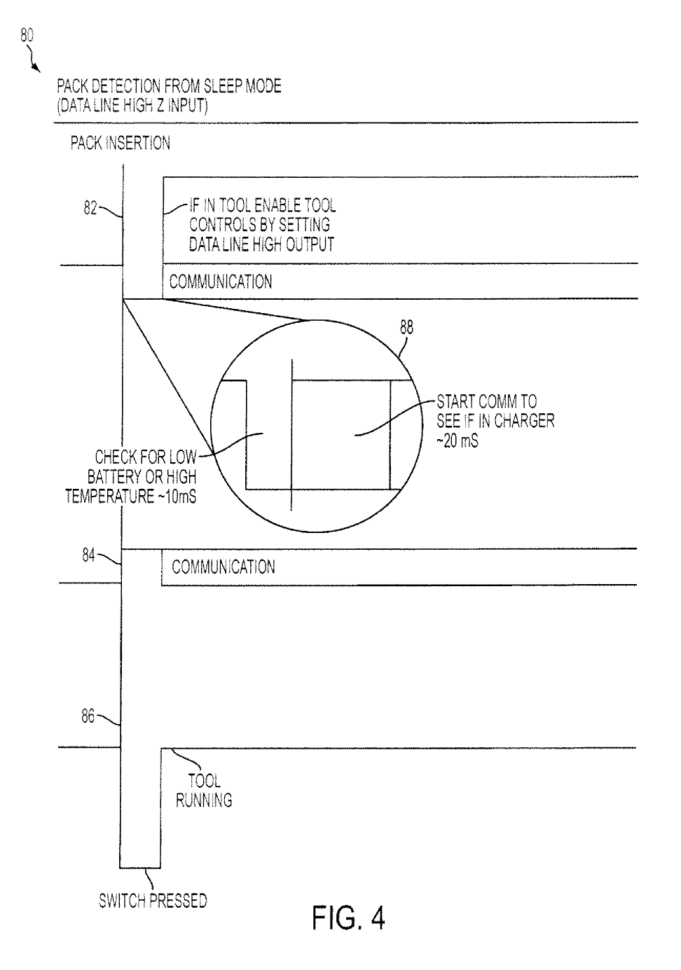

Referring now to FIG. 4, signal diagrams 80 demonstrate the signals at the control terminals of tool 12, battery pack 16, and charger 18 when battery pack 16 is connected to one of tool 12 and charger 18 from a sleep mode. Signal diagram 82 represents control terminal 32 of battery pack 16, signal diagram 84 represents control terminal 102 of charger 18, and the signal diagram 86 represents control terminal 52 of tool 12. Blow-up diagram 88 may represent control terminal 32 of battery pack 16 during the initial stages of waking from sleep mode. Sleep mode may be any time when battery pack 16 is not connected to one of tool 12 or charger 18. In sleep mode, circuitry 24 of battery pack 16 may provide a high impedance to control terminal 32.

When battery pack 16 is unconnected to any external device, it is in sleep mode such that circuitry 24 provides a high impedance output at control terminal 32. When the pack is connected with tool 12 with switch 58 closed or with charger 18, circuitry 41 of tool 12 or circuitry 108 of charger 18 may pull-down the voltage at control terminal 32 to a low voltage as depicted in signal diagram 82 and blow-up signal diagram 88. Circuitry 24 of battery pack 16 may detect the pull-down voltage provided at control terminal 32 and recognize that one of tool 12 or charger 18 is provided.

If circuitry 24 detects one of tool 12 or charger 18, it may perform diagnostic and sensing steps. As is depicted in the blow-up signal diagram 88, circuitry 24 may first perform self-diagnostics such as checking for low battery or high temperature in the battery pack 16 for a time period such as 10 milliseconds (ms). Circuitry 24 may then provide a 3 volt communication signal to control terminal 32. Circuitry 41 of tool 12 may not be responsive to a 3 volt communication signal received at control terminal 52. Circuitry 108 of charger 18 may respond to a 3 volt communication signal received at control terminal 102 and may respond with a 3 volt communication signal to circuitry 24 through control terminal 32 as depicted in signal diagrams 82 and 84.

As depicted in blow-up signal diagram 88, circuitry 24 of battery pack 16 may wait for a time period such as 20 ms to determine whether a response signal is provided by circuitry 108 of charger 18. If a response communication signal is provided within that time period, circuitry 24 of battery pack 16 and circuitry 108 of charger 18 may continue to communicate to control the charging of battery 22 by power supply 110 as depicted in signal diagrams 82 and 84. If circuitry 24 does not receive a response signal within the time period, circuitry 24 may connect control terminal 32 to the high side voltage such that circuitry 41 of tool 12 receives a voltage necessary to allow circuitry 41 to close a circuit to operate load 60 with power from battery 22, as is depicted in FIGS. 82 and 86. The voltage necessary to operate circuitry 41 may vary based on the particular circuit element utilized, and for example purposes may be 5 volts.

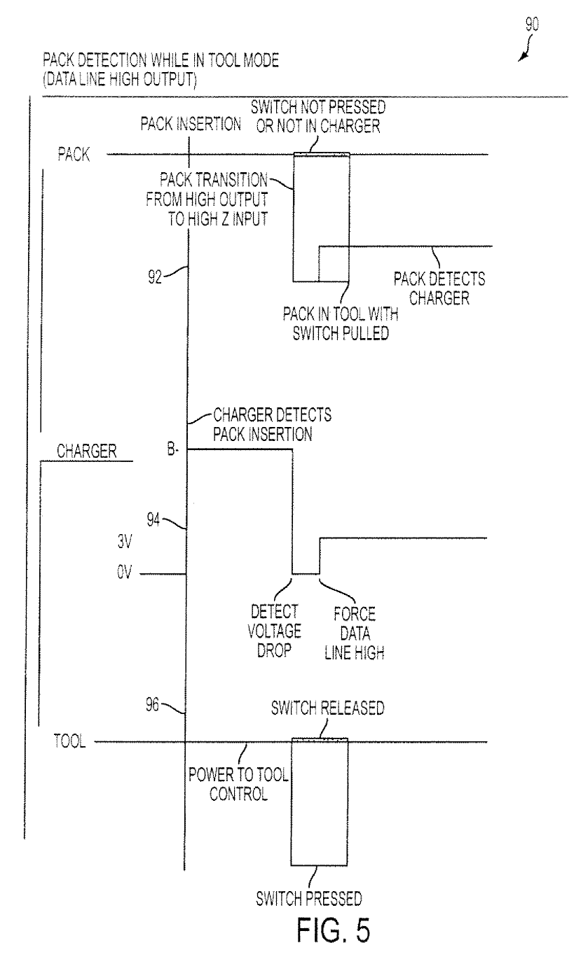

Referring now to FIG. 5, signal diagrams 90 demonstrate the signals at the control terminals of tool 12, battery pack 16, and charger 18 when battery pack 16 is operating in tool mode. Because there is no active communication between circuitry 24 of battery pack 16 and circuitry 41 of tool 12 once the tool begins to operate, it may be necessary to periodically check the status of control terminal 32 of battery pack 16. This may occur at predetermined intervals such as every 0.5 seconds.

At the predetermined interval, circuitry 24 may switch control terminal 32 from a high voltage side of battery 22 to a high impedance output as is depicted in signal diagram 82. If battery pack 16 is connected to charger 18, or if tool 12 is connected to battery pack 16 with switch 58 closed, a pull-down voltage may be provided to control terminal 32 from circuitry 41 and control terminal 52 of tool 12 or circuitry 108 and control terminal 102 of charger 18, as is depicted in signal diagrams 92, 94, and 96. Operation may then continue as described in FIG. 4.

If battery pack 16 is not connected to charger 18 or tool 12, or if switch 58 of tool 12 is open, battery pack 16 will not receive a pull-down voltage at control terminal 32. If battery pack 16 does not receive a pull-down voltage, circuitry 24 will continue to provide a high impedance output such that neither tool 12 nor charger 18 may operate with battery pack 16. Battery pack 16 may continue to provide the high impedance output until a pull-down voltage is provided as described in FIG. 4.

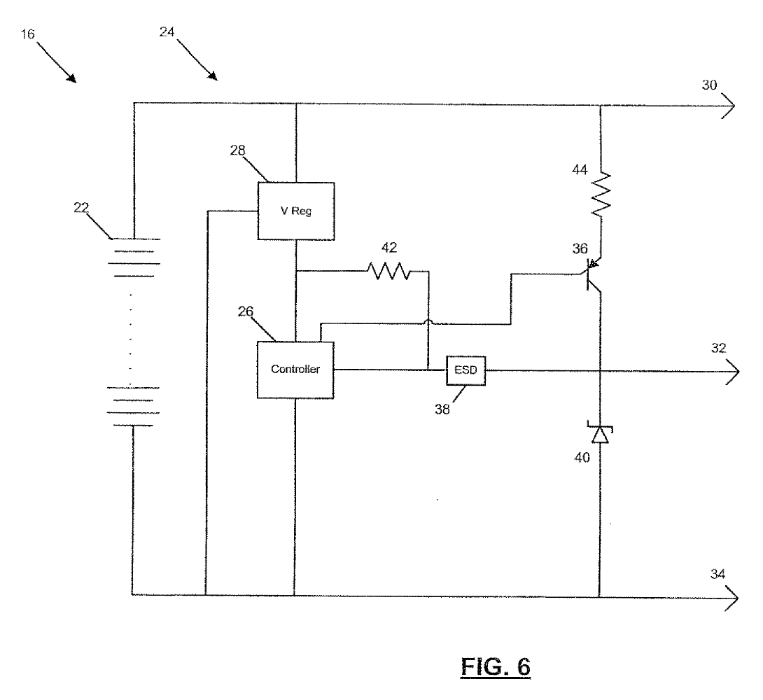

Referring now to FIG. 6, an exemplary schematic illustration of battery pack 16 is depicted. Although a particular circuit configuration is depicted and described, it should be understand that the circuit elements may be rearranged, added, or subtracted while still maintaining the necessary functionality. Battery pack 16 includes a battery 22, high-side terminal 30, control terminal 32, low side terminal 34, and circuitry 24. Battery 22 may be a lithium ion battery that may have a high voltage side associated with high-side terminal 30 and a low voltage side associated with low side terminal 34. High-side terminal 30, control terminal 32, and low side terminal 34 may be configured such that they provide electrical contact on an exterior surface of an enclosure (not shown) of battery pack 16. Battery 22 and circuitry 24 may be enclosed within the enclosure of battery pack 16.

Battery 22 may have a number of cells configured for a particular design voltage, which for example purposes may be 12 volts. Whatever the design voltage of battery 22 is, battery 22 may provide a reduced voltage over time when operated by a power tool. Battery 22 may need to be recharged once the battery 22 voltage drops below a predetermined voltage value less than the design voltage. For example, battery 22 may need to be recharged, and thus may not be operated with a power tool, when the voltage of any cell of battery 22 is less than 0.5 volts.

Circuitry 24 may include controller 26, voltage regulator 28, a switching element such as transistor 36, electrostatic discharge protection (ESD) 38, zener diode 40, and resistors 42 and 44. Voltage regulator 28 may be electrically connected to both the high voltage side and low voltage side of battery 22. Voltage regulator 28 may provide a reduced voltage such as three volts at an output of voltage regulator 28. The output of voltage regulator 28 may be connected to a voltage input of controller 26 and to resistor 42. Resistor 42 may connect the voltage input of controller 26 to an output port of controller 26. Controller 26 may also have an input at the low voltage side of battery 22 and another control output connected to transistor 36. A controller 26 output may be connected to ESD 38 which in turn may be connected to control terminal 32. ESD 38 may prevent disturbances caused by electrostatic discharge from damaging circuitry 24 within battery pack 16, and in particular may protect controller 26.

A source of transistor 36 may be connected to resistor 44 which in turn may be connected to the high voltage side of battery 22 and high-side terminal 30. A drain of transistor 36 may be connected to provide electrical connection between control terminal 32 and the high voltage side of battery 22 based on an input to a gate of transistor 36. The drain may also be electrically connected to ESD 38 and a cathode of zener diode 40. The gate of transistor 36 may be connected to a second output of controller 26.

The outputs of controller 26 may determine a signal provided to control terminal 32. When controller 26 provides a signal to the gate of transistor 36 to turn on transistor 36, a high voltage may be provided to control terminal 32 from the high side of battery 22 through resistor 44 and transistor 36. When transistor 36 is off, the signal provided to control terminal 32 may be based on the first output of controller 26. Controller 26 may provide 3 volt logic to control terminal 32 from the first output of controller 26 through ESD 38. Controller 26 may also provide a high impedance output such that the voltage at control terminal 32 is approximately 3 volts from the pull-up resistor 42 to the 3 volt output of voltage regulator 28.

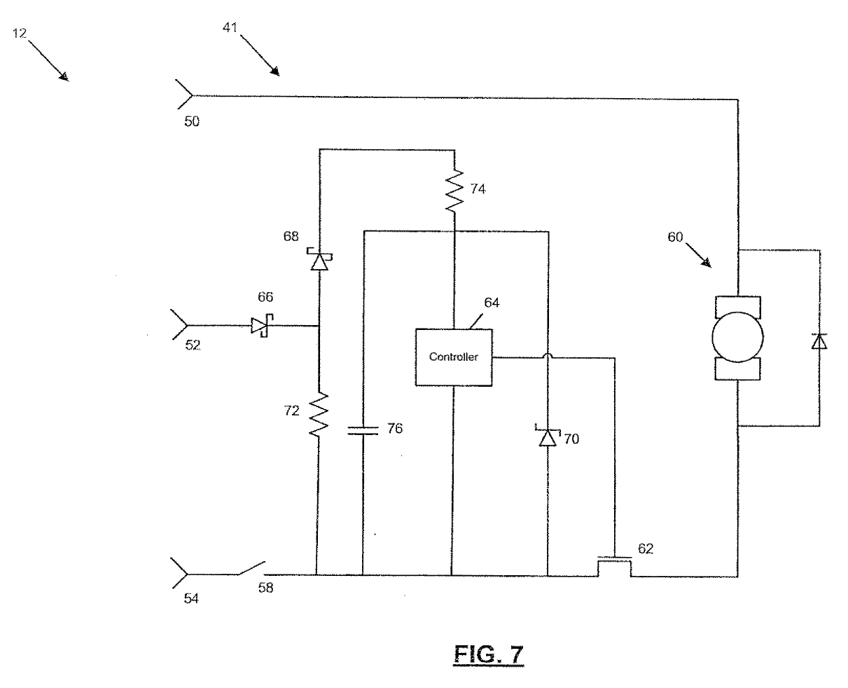

Referring now to FIG. 7, an exemplary schematic illustration of a power tool 12 for use with the battery pack of FIG. 6 is depicted. Although a particular circuit configuration is depicted and described, it should be understand that the circuit elements may be rearranged, added, or subtracted while still maintaining the necessary functionality. Power tool 12 includes circuitry 41, high-side terminal 50, control terminal 52, low side terminal 54, switch 58, and a load 60. High-side terminal 50, control terminal 52, and low side terminal 54 may be situated to connect at an exterior surface of power tool 12 such that high-side terminal 50 of power tool 12 may connect to high-side terminal 30 of battery pack 16, control terminal 52 of power tool 12 may connect to control terminal 32 of battery pack 16, and low side terminal 54 of power tool 12 may connect to low side terminal 34 of battery pack 16.

Switch 58 may be in communication with a mechanical switch or trigger element (not shown) of power tool 12 to selectively open or close switch 58. Circuitry 41 may include FET 62, variable speed controller 64, diodes 66, 68, and 70, resistors 72 and 74, and capacitor 76. Switch 58 may be connected in series between low side terminal 54 and FET 62 of circuitry 41. In this manner, a user controlling switch 58 may selectively electrically connect circuitry 41 and load 60 to the battery pack. As will be shown below, FET 62, as controlled by other circuitry 41 and signals from control terminal 32 of battery pack 16, may also connect load 60 to battery pack 16.

The anode of schottky diode 66 may be connected to control terminal 52 and the cathode of schottky diode 66 may be connected to pull-down resistor 72 and the anode of schottky diode 68. Pull down resistor 72 may be connected to the low side of load 60 and selectively connected to the low side of battery pack 16 when switch 58 is closed and low side terminal 54 is connected to low side terminal 34 of battery pack 16. When switch 58 is closed and control terminal 52 is connected through control terminal 32 of battery pack 16 to a 3 volt pull-up voltage associated with the controller 26 high-impedance output, pull-down resistor 72 may pull-down the voltage at control terminal 52, and thus the voltage at control terminal 32. Pull-down resistor 72 may pull-down the voltage by having a resistance value approximately equal or lower than the value of pull-up resistor 42 of battery pack 16.

The cathode of schottky diode 68 may be connected to resistor 74, the other side of which may be connected to zener diode 70, capacitor 76, and an input to variable speed controller 64. Variable speed controller 64 may be connected to low side terminal 54 based on a status of switch 58. Variable speed controller may have an input associated with a user selected power setting such as a trigger or selection switch (not shown) of power tool 12. Variable speed controller 64 may be in communication with FET 62 to provide pulse-width modulated (PWM) control signal to the gate of FET 62. Although variable speed controller 64 may be any device capable of providing a PWM signal to FET 62, for example purposes variable speed controller may be a 555 timer chip configured to output a PWM signal and connected to a driver circuit element to drive FET 62.

The operation of switch 58, variable speed controller 64, and FET 62 may control power tool 12 by selectively providing power to load 60. Either switch 58 or FET 62 may open a circuit preventing the operation of load 60. Variable speed controller 64 may selectively provide a PWM signal to FET 62 such that less than full power may be provided to load 60 even though switch 58 is closed.

Switch 58 and variable speed controller 64 may also interact with battery pack 16 through control terminal 52. For example, when switch 58 is closed and battery pack 16 has provided a 3 volt pull up voltage at control terminal 32 of battery pack 16, pull-down resistor 72 may pull-down the voltage at control terminal 32 as described above. Variable speed controller 64 may not operate at 3 volts such that the only voltage source through control terminal 32 and control terminal 52 that may allow controller 64 to operate may be a high voltage associated with transistor 36 of battery pack 16 connecting control terminal 32 of battery pack 16 to the high side voltage of battery 22.

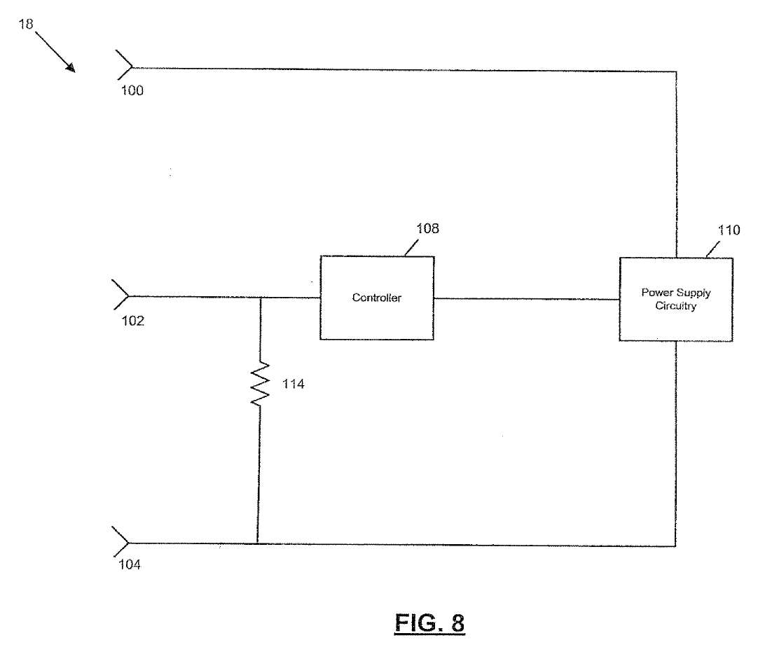

Referring now to FIG. 8, an exemplary battery charger 18 for charging battery 22 of battery pack 16 is depicted. Although a particular circuit configuration is depicted and described, it should be understand that the circuit elements may be rearranged, added, or subtracted while still maintaining the necessary functionality. Battery charger 18 may include high-side terminal 100, control terminal 102, low side terminal 104, circuitry 108, and power supply 110. Circuitry 108 may include controller 112 and pull-down resistor 114. Pull-down resistor 114 may connect control terminal 32 of battery pack 16 via control terminal 102 to the low side of battery 22 through low side terminal 104. Because of the relative values of pull-up resistor and pull-down resistor 72, the voltage at control terminal 32 and control terminal 102 may be a low value, i.e., a small percentage of the pull-up voltage of 3 volts, as long as the only voltage source at control terminals 32 and 52 is the 3 volt pull-up voltage.

Controller 112 may selectively provide a 3 volt signal at the output of controller 112 connected to control terminal 102. In this manner, controller 112 of charger 18 may communicate with controller 26 of battery pack 16 through 3 volt logic signals. Parameters to be communicated may include values such as a battery pack voltage or temperature. Based on the communications between battery pack 16 and charger 18, controller 112 may control power supply circuitry 110 which may be provided in series with source 110 and low side terminal 104 to selectively provide charging power to battery 22 of battery pack 16.

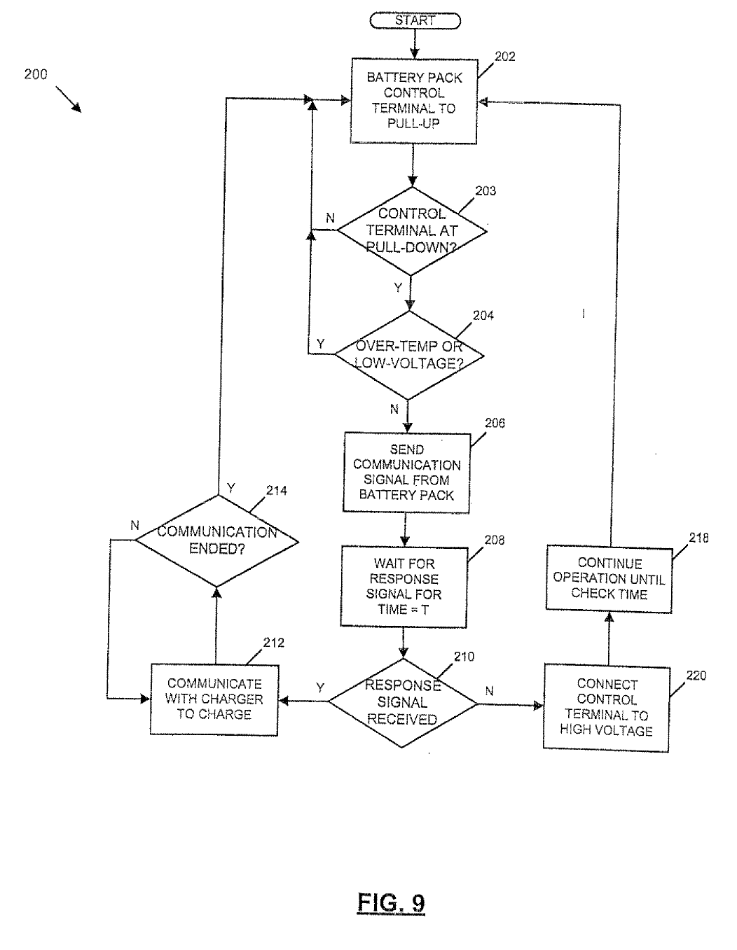

Referring now to FIG. 9, a flow diagram 200 of operation of battery pack 16 with one of power tool 12 and/or charger 18 is depicted. At block 202, the battery pack control terminal may be set to the pull-up voltage of 3 volts. Controller 26 may provide an output to the gate of transistor 36 such that transistor 36 does not connect control terminal 32 to the high voltage side of battery 22. Controller 26 also may provide a high impedance output such that the voltage at control terminal 32 is approximately three volts from the pull-up resistor 42. Control logic 200 may continue to block 203.

At block 203, controller 26 may determine whether the voltage at control terminal 32 has been pulled down to a value less than a predetermined presence voltage by either a power tool 12 or charger 18. Power tool 12 may pull-down the voltage at terminal 32 by switch 58 closing the circuit such that resistor 72 connects control terminal 32 to the low voltage side of battery 22 through control terminal 52, schottky diode 66, and resistor 72. Charger 18 may pull-down the voltage at control terminal 32 by connecting control terminal 32 to the low voltage side of battery 22 through control terminal 102, resistor 114, charger low side terminal 104, and battery pack low side terminal 34. If controller 26 does not sense a voltage lower than the predetermined presence voltage, control logic 200 may return to block 202. If controller 26 does sense a voltage at control terminal 32 less than the predetermined presence voltage, control logic 200 may continue to block 204.

At block 204, controller 26 may monitor battery pack parameters (not shown) such as voltage and temperature. If the temperature is greater than a predetermined temperature threshold such as 70° C. or the voltage is less than a predetermined voltage threshold such as 0.5 volts for any cell, control logic 200 may return to block 202. In this manner, battery 22 may not be charged or used with a tool if conditions are not appropriate.

It should be recognized that other parameters other than voltage or temperature could be measured and that at block 204 and that an over-temperature, low voltage or other condition could result in only preventing one of tool operation or charging. For example, a flag could be set for a low voltage condition that would allow charging of the battery pack 16 with charger 18 but would not allow the battery pack 16 to be used to provide power to a power tool. Control logic 200 may continue to block 206.

At block 206 controller 26 may send a 3 volt logic communication signal through control terminal 32 to a device attached to control terminal 32. Control logic 200 may continue to block 208. At block 208 controller 26 may wait to receive a response signal at terminal 32. Controller 26 may wait for a predetermined time equal to T such as 20 milliseconds. If a power tool 12 is attached to battery pack 16, power tool 12 may not communicate with the three volt communication signals from controller 26. Thus, a power tool will not send a communication response. If a charger 18 is attached to battery pack 16, controller 112 of charger 18 may respond with a 3 volt communication signal. Control logic 200 may continue to block 210.

At block 210 controller 26 may determine whether a response signal was received. If the response signal was received, control logic 200 may continue to block 212. If the response signal was not received, control logic 200 may continue to block 220. At block 212, controller 26 may provide three volt communication signals back and forth with controller 112 of charger 18. In this manner, the charger 18 may operate to charge battery 22 of battery pack 16. Control logic 200 may continue to block 214 from block 212.

At block 214, a battery pack 16 may be removed from the charger 18 such that communication has ended. If communication has ended, control logic 200 may continue to block 202. If communication has not ended, control logic 200 may continue to block 212 and continue communication between charger 18 and battery pack 16.

At block 220, controller 26 may connect the control terminal 32 to the high voltage side of battery 22. Controller 26 may provide an enabling signal to the gate of transistor 36 such that transistor 36 is on. This may allow a high voltage to be transferred through resistor 44 to control terminal 32. The voltage supplied may be received by variable speed controller 64 of power tool 12 such that power tool 12 may operate based on user inputs. Control logic 200 may continue to block 218. At block 218, control logic 200 may continue to connect control terminal 32 to a high voltage through transistor 36 for a predetermined time such 0.5 seconds. Once the 0.5 seconds is complete, control logic 200 may continue to block 202 to check if the tool has been turned off such as by changing the switch 58 status, or has been removed, or if the charger has been attached. Operation may continue looping in this manner.

Those skilled in the art can now appreciate from the foregoing description that the broad teachings of the present invention can be implemented in a variety of forms. Therefore, while this invention has been described in connection with particular examples thereof, the true scope of the invention should not be so limited since other modifications will become apparent the skilled practitioner upon a study of the drawings, the specification and the following claims.

What is claimed is:

1. A rechargeable battery pack comprising:
a battery having a high voltage side and a low voltage side;
a positive terminal accessible external of the battery pack and connected to the high voltage side of the battery;
a negative terminal accessible external of the battery pack and connected to the low voltage side of the battery;
a control terminal accessible external of the battery pack;
a switching element electrically connected between the control terminal and the high voltage side of the battery; and
a control module operable to control the switching element so that the control terminal is selectively coupled to the high voltage side of the battery.

2. The battery pack of claim 1 wherein the control terminal is the only terminal accessible external to the battery pack that may have a voltage that is not the battery high voltage side or the battery low voltage side.

3. The battery pack of claim 1 wherein the control module is operable to determine whether the battery pack is operably coupled to a power tool or a battery charger and close the switching element when the battery pack is operably coupled to the power tool, thereby coupling the control terminal to the high voltage side of the battery.

4. The battery pack of claim 3 wherein the control module opens the switching element when the battery pack is operably coupled to the battery charger.

5. The battery pack of claim 4 wherein the control module is electrically coupled to the control terminal and operable to output and receive a communication signal at the control terminal at a voltage less than the high voltage side of the battery.

6. The battery pack of claim 5 wherein the control module outputs the communication signal and is operable to close the switching element when a response to the communication signal is not received within a predetermined time.

7. The battery pack of claim 1 wherein the control module is operable to sense a power tool or battery charger attached to the battery pack based on a voltage at the control terminal less than a predetermined presence voltage.

8. The battery pack of claim 7 wherein the control module is electrically coupled to the control terminal and operable to output a communication signal and receive a communication signal response at the control terminal after a voltage at the control terminal less than the predetermined presence voltage is sensed, wherein the communication signal voltage is less than the battery high voltage side.

9. The battery pack of claim 8 wherein the control module outputs the communication signal and is operable to close the switching element when the communication signal response is not received within a predetermined time.

10. The battery pack of claim 8 wherein the control module outputs the communication signal and is operable to open the switching element and send further communication signals when the communication signal response is received within a predetermined time.

11. A rechargeable battery pack comprising:
a battery having a high voltage side and a low voltage side;
a high-side terminal connected to the battery high voltage side;
a low side terminal connected to the battery low voltage side;
a control terminal; and
a control module selectively connecting the control terminal to one of a battery high voltage side voltage, a voltage less than the battery high voltage side voltage, and a communication signal of the control module transitioning between a high communication voltage and a low communication voltage.

12. The battery pack of claim 11 wherein the control module is operable to selectively connect the control terminal to the supply voltage when the battery pack is connected to a power tool.

13. The battery pack of claim 11 wherein the control module is operable to selectively connect the control terminal to the default voltage until the voltage of the control terminal is pulled down to a voltage less than a predetermined presence voltage.

14. The battery pack of claim 13 wherein the control module is operable to selectively connect the control terminal to the communication signal when the voltage of the control terminal is pulled down to a voltage less than a predetermined presence voltage.

15. The battery pack of claim 14 wherein the control module is operable to continue providing the communication signal to the control terminal if a communication signal is received at the control terminal.

16. The battery pack of claim 15 wherein the control module is operable to connect the control terminal to the supply voltage if a communication signal is not received at the control terminal within a predetermined time.

17. A tool operable to connect to a battery pack, comprising:
a high voltage input;
a low voltage input;
a load;
a switching element operable to open or close a series circuit path including the high voltage input, the load, and the low voltage input;
a control input; and
a control module operable to control the switching element, wherein the control module is powered by the control input and operates at voltage of at least 5 volts.

18. The tool of claim 17, wherein the switching element is open when the voltage supplied to the control module is insufficient to operate the control module.

19. A method for operating a battery pack, the battery pack having a positive terminal connected to a high voltage side of a battery enclosed therein, a negative terminal connected to a low voltage side of the battery, and a control terminal, comprising:
sending an inquiry communication signal from the battery pack via the control terminal;
sending an additional communication signal from the battery pack via the control terminal when a response signal to the inquiry communication signal is received at the control terminal; and
connecting the control terminal to the high voltage side of the battery when a response signal to the inquiry communication signal is not received by the battery pack.

20. The method of claim 19, further comprising waiting a predetermined time after sending the inquiry communication signal for the response signal.

21. The method of claim 19, further comprising:
providing a pull-up voltage to the control terminal;
monitoring the control terminal for a voltage less than a predetermined presence threshold; and
sending the inquiry communication signal from the battery pack through the control terminal when the voltage of the control terminal is less than the predetermined presence threshold.

22. A method of operating a battery pack, comprising:
applying a pull-up voltage to a control terminal of the battery pack;
determining whether a voltage of the control terminal is less than a predetermined presence voltage; and
providing signals to the control terminal when the voltage of the control terminal is less than the predetermined presence voltage, including:
providing a communication signal from a control module of the battery pack to the control terminal;
determining whether a response is received at the control terminal; and
providing a voltage connected to a high voltage side of the battery pack through a circuit element to the control terminal when the response is not received at the control terminal.

23. The method of claim 22 wherein the providing the voltage includes controlling a switching element to electrically connect the control terminal to a high voltage side of the battery pack.

24. The method of claim 22 further comprising providing further communication signals when the response is received at the control terminal.

25. The method of claim 22 further comprising providing a high voltage from a high voltage side of the battery pack to a high voltage terminal and a low voltage from a low voltage side of the battery to a low voltage terminal.
